(19) United States
(12) Patent Application Publication
(10) Pub. No.: US 2012/0327659 A1
(43) Pub. Date: Dec. 27, 2012

(54) LED ILLUMINATING DEVICE AND LED MATRIX

(75) Inventors: DER-HO CHI, Tu-Cheng (TW); YANG-JUI CHAO, Tu-Cheng (TW); JI-BAO FU, Shenzhen City (CN); MI TANG, Shenzhen City (CN); KUAN-HONG HSIEH, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/195,015

(22) Filed: Aug. 1, 2011

(30) Foreign Application Priority Data
Jun. 24, 2011 (CN) 201110173107.2

(51) Int. Cl. F21S 4/00

(52) U.S. Cl. 362/249.06

(57) ABSTRACT

A device providing illumination by LED includes an illuminating module including a circuit board. The circuit board includes a plurality of LED groups arranged thereon, where each of the plurality of LED groups includes a plurality of LED units connected with each other in series. The plurality of LED units forms an LED matrix, and at least three LED units in each row of the LED matrix belong to different LED groups. Each of the LED units in each column of the LED matrix belongs to a respective LED group. An LED matrix is also provided.

### BACKGROUND

1. Technical Field

The present disclosure relates to illuminating devices, especially to illumination by LED and an LED matrix capable of avoiding an obvious dark line when one or more LEDs is damaged.

2. Description of Related Art

Compared to many other kinds of illuminating devices, LED illuminating devices have many advantages, such as high luminous efficiency, low power consumption, and long service life. Nevertheless, LED lights have disadvantages. FIG. 1 shows an arrangement of LED units 121 of an LED lamp tube in accordance with related art. The LED units 121 shown constitute a matrix. The LED units 121 in each column are connected in series. When one or more is damaged, all of the LED units 121 of the whole column cease working, which creates an obvious line of darkness.

Therefore, what is needed is an LED illuminating device and an LED matrix that can overcome the above mentioned limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of the LED arrangement of an LED illuminating device of related art.

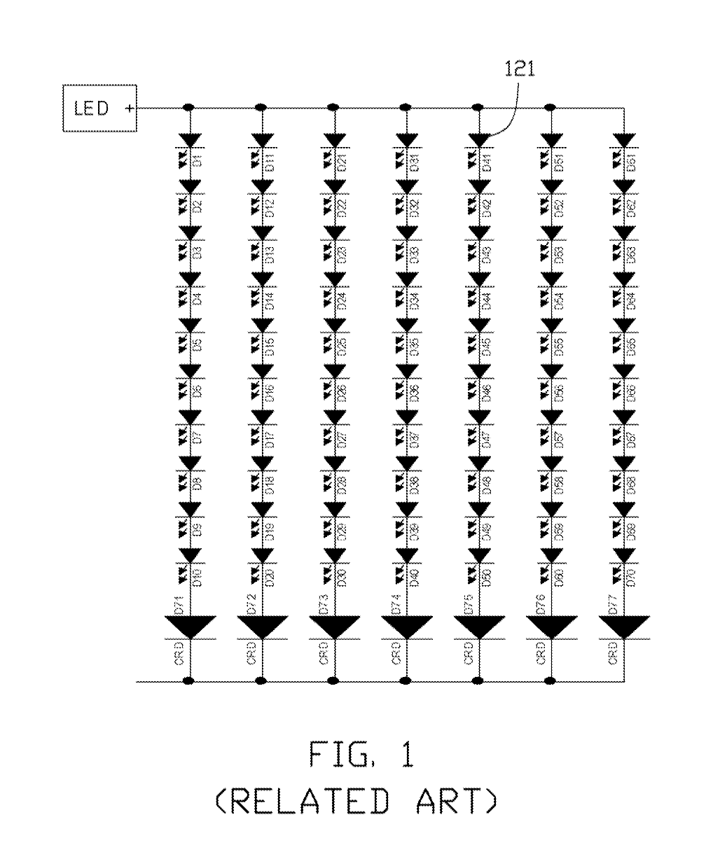

FIG. 2 is an isometric view of an LED illuminating device in accordance with the present disclosure.

FIG. 3 is an exploded view of part of the LED illuminating device of FIG. 2.

FIG. 4 is a schematic, plan view showing the arrangement of LEDs of the

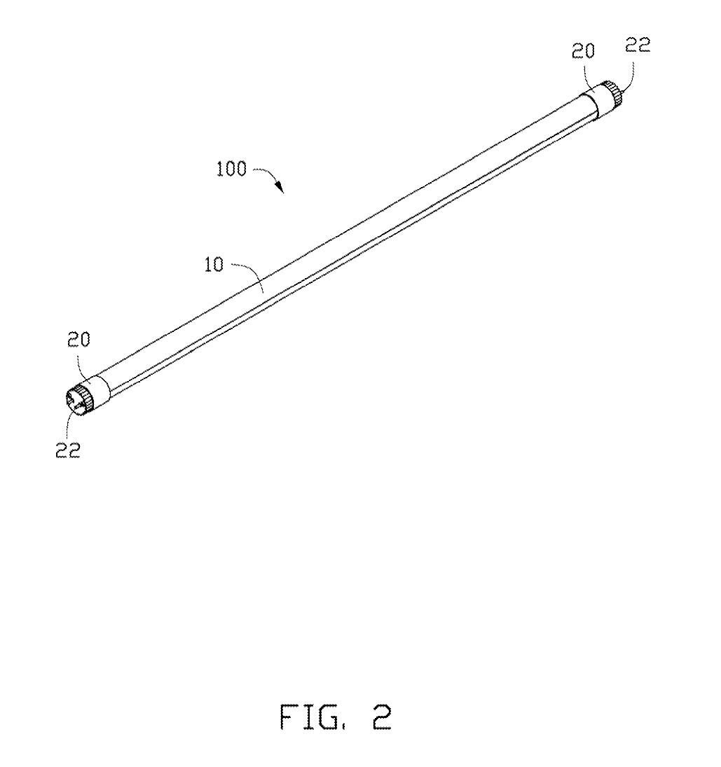

LED illuminating device of FIG. 2.

### DETAILED DESCRIPTION

Embodiments of the present disclosure will now be described in detail, with reference to the accompanying drawings.

Referring to FIG. 2, a light emitting diode (LED) illuminating device 100 according to an embodiment is disclosed. The LED illuminating device 100 includes an illuminating module 10, and two connectors 20. The connectors 20 are fixed to opposite ends of the illuminating module 10. The illuminating module 10 is fixed and electrically connected to a support (not shown) by two contact pins 22 of the connectors 20.

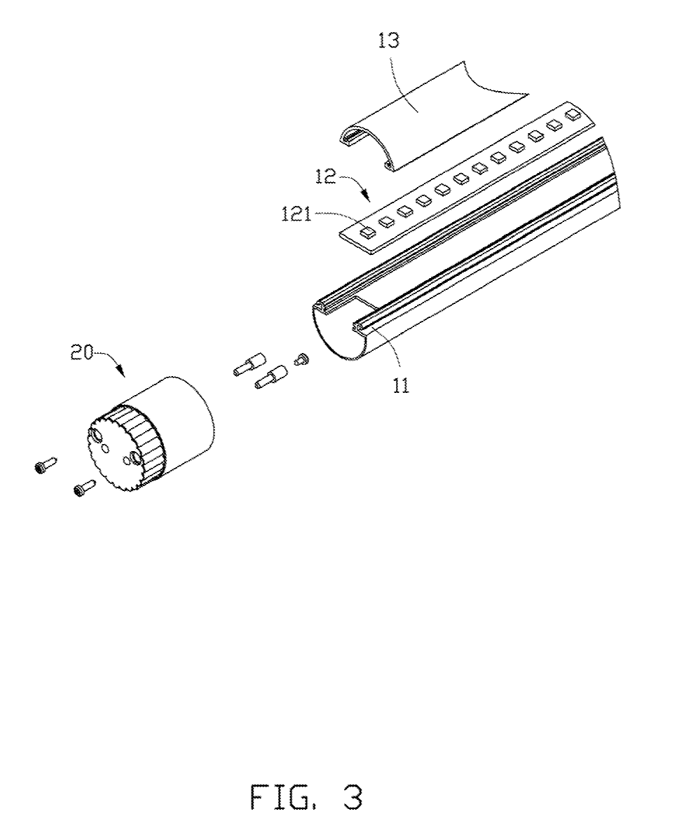

Referring to FIG. 3, the illuminating module 10 also includes a heat dispersing member 11, a circuit board 12, and a translucent cover 13. In the embodiment, the heat dispersing member 11 and the translucent cover 13 are both half-cylindrical in shape and cooperatively form a hollow tube. In the embodiment, the heat dispersing member 11 is made of heat dispersing material with good heat conductivity, such as aluminium alloy. A number of LED units 121 are arranged on the circuit board 12, and each LED unit 121 is electrically connected to the contact pins 22 of the connectors 20. The translucent cover 13 is made of translucent, fire-resistant material. The circuit board 12 and the translucent cover 13 are both mounted to the heat dispersing member 11.

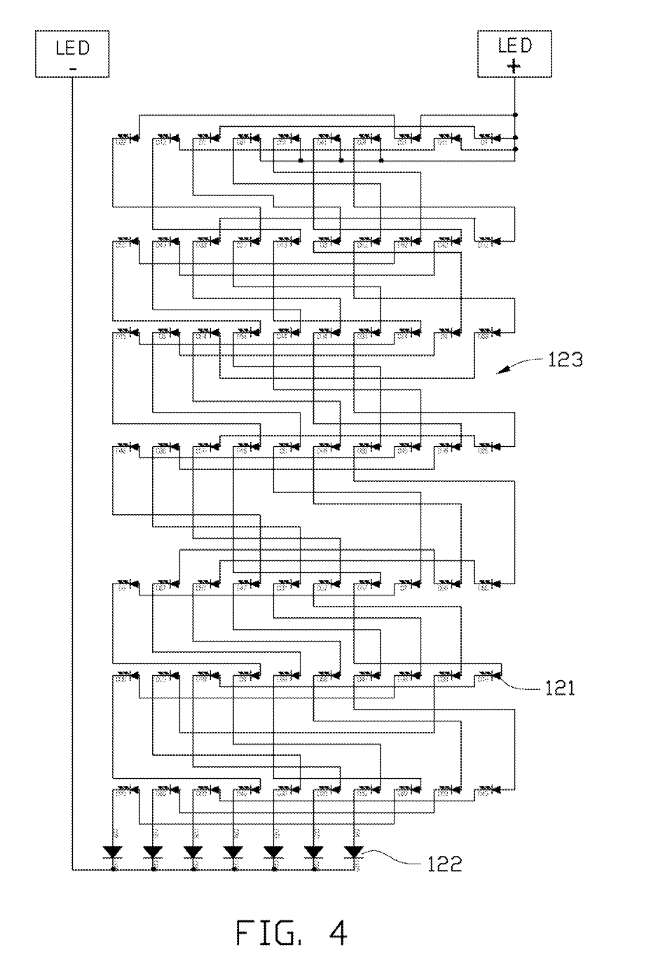

Referring to FIG. 4, the LED units 121 are arranged on the circuit board 12 in a matrix 123. The LED matrix 123 includes at least two LED groups each formed by a number of LED units 121 connecting with each other in series. The at least two LED groups are connected to each other in parallel. Each LED group includes at least two LED units 121 and a Current Regulative Diode (CRD) 122. The Current Regulative Diode (CRD) 122 is electrically connected to a power supply (not shown). In the embodiment, seven LED groups are arranged on the circuit board 12, and each LED group includes ten LED units 121 and one CRD 122. The CRD 122 is configured for outputting a constant current over a wide voltage range to ensure the stability of the LED units 121, thereby increasing the service life of the LED units 121. In the embodiment, at least three LED units 121 in each row of the matrix 123 belong to different and independent LED groups.

In the embodiment illustrated in FIG. 4, the LED matrix 123 constituted by the seven LED groups includes ten columns and seven rows. The seven LED units 121 in each column respectively belong to the seven LED groups. Since the LED units 121 of one LED group are arranged in different rows and columns of the matrix 123, no obvious dark line will be created, or noticeable, if one of the LED groups ceases working for any reason.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and the arrangement of parts within the principles of the present disclosure to the full extent indicated by the broad general meaning of the terms in which the appended claims are expressed.

What is claimed is:

1. An LED illuminating device comprising:
an illuminating module comprising a circuit board, the circuit board comprising a plurality of LED groups arranged thereon, each of the plurality of LED groups comprising a plurality of LED units connected with each other in series, the plurality of LED units forming an LED matrix comprising a plurality of rows and columns, wherein at least three LED units in each row of the LED matrix belong to different and independent ones of the plurality of LED groups.

2. The LED illuminating device of claim 1, wherein the LED illuminating device further comprises a heat dispersing member and a translucent cover, the heat dispersing member and the translucent cover are both half-cylindrical in shape and cooperatively form a hollow tube.

3. The LED illuminating device of claim 2, wherein the heat dispersing plate is made of aluminium alloy plating.

4. The LED illuminating device of claim 2, wherein the translucent cover is substantially semi-circular in cross-section and is made of translucent fire-resistant material.

5. The LED illuminating device of claim 1, wherein the LED illuminating device further comprises two connectors, the two connectors are fixed to opposite ends of the illuminating module, each LED unit is electrically connected to contact pins of the connectors.

6. The LED illuminating device of claim 1, wherein each LED group comprises a Current Regulative Diode (CRD) that is electrically connected to the LED units in the LED group.

7. The LED illuminating device of claim 1, wherein each of the LED units in each column of the LED matrix belongs to a respective LED group.

8. The LED illumination device of claim 7, wherein the matrix comprises seven columns and ten rows.

9. An LED matrix comprising:
a plurality of LED groups, each of the plurality of LED groups comprising a plurality of LED units connected with each other in series, the plurality of LED units forming the LED matrix comprising a plurality of columns and rows, wherein at least three LED units in each row of the LED matrix belongs to different and independent ones of the plurality of LED groups.

10. The LED matrix of claim 9, wherein each of the LED groups comprises a Current Regulative Diode (CRD) that is electrically connected to the LED units in the LED group.

11. The LED matrix of claim 10, wherein each of the LED units in each column of the LED matrix belongs to a respective LED group.

12. The LED matrix of claim 11, wherein the LED matrix comprises at least ten columns and the LED groups comprises at least seven groups.
